(19) United States
(12) Patent Application Publication
(10) Pub. No.: US 2025/0135873 A1
(43) Pub. Date: May 1, 2025

(54) WIND SHIELDING SYSTEM AND METHOD FOR REGULATING AIRFLOW TO RADIATOR COOLING PACKAGE OF VEHICLE

(71) Applicant: Volvo Truck Corporation, GÖTEBORG (SE)

(72) Inventors: Shital Dubey, Bangalore (IN); Manoj Kumar S., Bangalore (IN)

(21) Appl. No.: 18/730,569

(22) PCT Filed: Mar. 29, 2022
(86) PCT No.: PCT/IB2022/052911

§ 371 Date: Jul. 19, 2024

(51) Int. Cl. B60K 11/08; B60K 11/04

(52) U.S. Cl. CPC B60K 11/085; B60K 11/04; B60Y 2400/302

(57) ABSTRACT

Wind shielding system and method for a radiator cooling package of a vehicle are disclosed. The wind shielding system has a wind shielding screen, a temperature sensor for detecting an air temperature of an ambient air surrounding the radiator cooling package and an actuator for moving the wind shielding screen to a closed configuration with respect to the radiator cooling package by an electronic control unit based on the detected air temperature. The wind shielding screen in the closed configuration impedes formation of ice on the radiator cooling package from an airflow at the detected air temperature by covering the radiator cooling package. A vehicle having the wind shielding system to perform the wind shielding method is also provided. A computer program product that when executed by the wind shielding system causes the wind shielding system to perform the wind shielding method is also provided.

### TECHNICAL FIELD

The present disclosure relates to a wind shielding system and a wind shielding method for regulating an amount of airflow to a radiator cooling package of a vehicle. The present disclosure also relates to a vehicle having the wind shielding system and a computer program product that when executed by the wind shielding system causes the wind shielding system to perform the wind shielding method.

### BACKGROUND

When a vehicle is running in a cold weather especially in a cold country, thick ice (ice is water in the solid phase) may be easily formed between radiator fins and a bug screen or between a shutter and a bug screen due to exposure to cold ram air. Such thick ice may block an airflow to a vehicle cooling package, and may be detrimental to cooling performance of the vehicle cooling package. It may further lead to: decreased usage life of the vehicle cooling package, increased maintenance cost, corrosion and rust of the vehicle cooling package due to low temperature, slow heat-up of an engine, slow warming-up of a cab, poor fuel efficiency, and poor energy management. Additionally, in order to remove the thick ice from the vehicle cooling package, the driver is required to come down from vehicle, which may be dangerous and life threatening especially during winter storm

### SUMMARY

According to some embodiments of inventive concepts, a wind shielding system is provided. The wind shielding system may include a wind shielding screen, an electronic control unit (ECU), a temperature sensor and an actuator. The wind shielding screen may be configured to be located adjacent to the radiator cooling package, the temperature sensor and the actuator may be each electrically coupled with the ECU, the temperature sensor may be configured to detect an air temperature of an ambient air surrounding the radiator cooling package, the actuator may be operatively coupled with the wind shielding screen and may be controllable by the ECU to move the wind shielding screen between a closed configuration and an open configuration with respect to the radiator cooling package based on a determination whether ice may or may not become formed on the radiator cooling package from an airflow at the detected air temperature, and wherein the wind shielding screen in the closed configuration may be configured to at least partially impede the airflow from flowing to the radiator cooling package by at least covering the radiator cooling package and thus to at least partially impede formation of ice on the radiator cooling package from the airflow.

According to some embodiments of inventive concepts, a vehicle is provided. The vehicle may include a radiator cooling package and a wind shielding system. The wind shielding system may include a wind shielding screen, an electronic control unit (ECU), a temperature sensor and an actuator. The wind shielding screen may be located adjacent to the radiator cooling package, the temperature sensor and the actuator may be each electrically coupled with the ECU, the temperature sensor may be configured to detect an air temperature of an ambient air surrounding the radiator cooling package, the actuator may be operatively coupled with the wind shielding screen and may be controllable by the ECU to move the wind shielding screen between a closed configuration and an open configuration with respect to the radiator cooling package based on a determination whether ice may or may not become formed on the radiator cooling package from an airflow at the detected air temperature, and the wind shielding screen in the closed configuration may be configured to at least partially impede the airflow from flowing to the radiator cooling package by at least covering the radiator cooling package and thus to at least partially impede formation of ice on the radiator cooling package from the airflow.

According to some embodiments of inventive concepts, a wind shielding method is provided. The wind shielding method may include locating a wind shielding screen of a wind shielding system of a vehicle adjacent to a radiator cooling package of the vehicle, electrically coupled each of a temperature sensor and an actuator of the wind shielding system with an electronic control unit (ECU) of the wind shielding system, detecting an air temperature of an ambient air surrounding the radiator cooling package by the temperature sensor, operatively coupling the actuator with the wind shielding screen, controlling the actuator by the ECU to move the wind shielding screen between a closed configuration and an open configuration with respect to the radiator cooling package based on a determination whether ice may or may not become formed on the radiator cooling package from an airflow at the detected air temperature, at least partially impeding the airflow from flowing to the radiator cooling package by at least covering the radiator cooling package via moving the wind shielding screen to the closed configuration, thereby at least partially impeding formation of ice on the radiator cooling package from the airflow.

According to some embodiments of inventive concepts, a computer program product is provided. The computer program product may include a non-transitory computer readable medium storing a program code that when executed by a wind shielding system for a radiator cooling package of a vehicle causes the wind shielding system to locate a wind shielding screen of the wind shielding system adjacent to the radiator cooling package, electrically couple each of a temperature sensor and an actuator of the wind shielding system with an electronic control unit (ECU) of the wind shielding system, detect an air temperature of an ambient air surrounding the radiator cooling package by the temperature sensor, operatively couple the actuator with the wind shielding screen, control the actuator by the ECU to move the wind shielding screen between a closed configuration and an open configuration with respect to the radiator cooling package based on a determination whether ice may or may not become formed on the radiator cooling package from an airflow at the detected air temperature, at least partially impede the airflow from flowing to the radiator cooling package by at least covering the radiator cooling package via moving the wind shielding screen to the closed configuration, thereby at least partially impeding formation of ice on the radiator cooling package from the airflow.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram illustrating a vehicle having a radiator cooling package and a wind shielding system for regulating an amount of airflow to the radiator cooling package according to some embodiments of inventive concepts;

FIG. 2 is a schematic diagram illustrating that a wind shielding screen of the wind shielding system prevents an airflow from flowing to the radiator cooling package according to some embodiments of inventive concepts;

FIG. 3 is a schematic diagram illustrating the wind shielding screen in a closed configuration according to some embodiments of inventive concepts;

FIG. 4 is a schematic diagram illustrating the wind shielding screen in an open configuration according to some embodiments of inventive concepts;

FIG. 5 is a schematic diagram illustrating the wind shielding screen in a partially closed/open configuration according to some embodiments of inventive concepts;

FIG. 6 is a schematic diagram illustrating that the wind shielding screen prevents the airflow from flowing to a radiator of the radiator cooling package according to some embodiments of inventive concepts;

FIG. 7 is a schematic diagram illustrating that the wind shielding screen prevents the airflow from flowing to a condenser of the radiator cooling package according to some embodiments of inventive concepts;

FIG. 8 is a schematic diagram illustrating that the wind shielding screen prevents the airflow from flowing to an insect screen of the radiator cooling package according to some embodiments of inventive concepts;

FIG. 9 is a schematic diagram illustrating that the wind shielding screen prevents the airflow from flowing to a grill of the radiator cooling package according to some embodiments of inventive concepts;

FIG. 10 is a schematic diagram illustrating an actuator having a driving unit engaged with a rolling unit onto which the wind shielding screen is wound around a winding axis according to some embodiments of inventive concepts;

FIG. 11 is a schematic diagram illustrating the actuator having the driving unit engaged with the rolling unit from which the wind shielding screen is unwound around the winding axis according to some embodiments of inventive concepts;

FIG. 12 is a schematic diagram illustrating that the driving unit moves the rolling unit along a trajectory substantially perpendicular to the winding axis according to some embodiments of inventive concepts;

FIG. 13 is a schematic diagram illustrating that the rolling unit starts moving along the trajectory and winding the wind shielding screen according to some embodiments of inventive concepts;

FIG. 14 is a schematic diagram illustrating that the rolling unit finishes moving along the trajectory and winding the wind shielding screen according to some embodiments of inventive concepts;

FIG. 15 is a schematic diagram illustrating that a cutout window is formed on the wind shielding screen to expose a portion of the radiator cooling package and is shifted along with movement of the wind shielding screen to expose another portion of the radiator cooling package according to some embodiments of inventive concepts;

FIG. 16A is a schematic diagram illustrating that the cutout window allows the airflow to pass therethrough and to flow to the portion of the radiator cooling package according to some embodiments of inventive concepts; and

FIG. 16B is a schematic diagram illustrating that the cutout window shifts along with movement of the wind shielding screen to allow the airflow to pass therethrough and to flow to the another portion of the radiator cooling package according to some embodiments of inventive concepts; and

FIG. 17 is a schematic diagram illustrating a computer program product comprising a non-transitory computer readable medium storing a program code configured to be executed by the wind shielding system for regulating the amount of airflow to the radiator cooling package according to some embodiments of inventive concepts.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

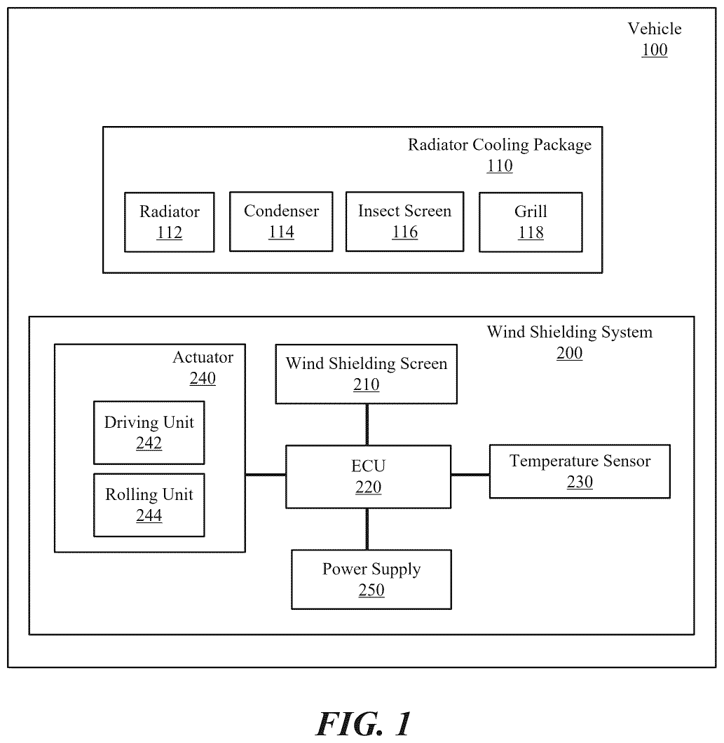

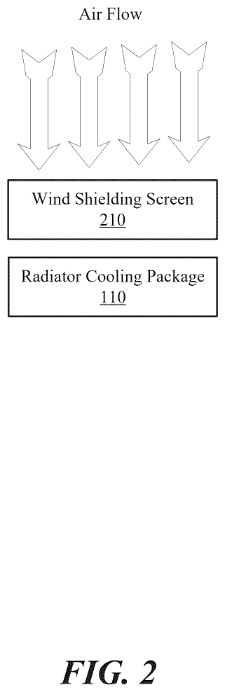

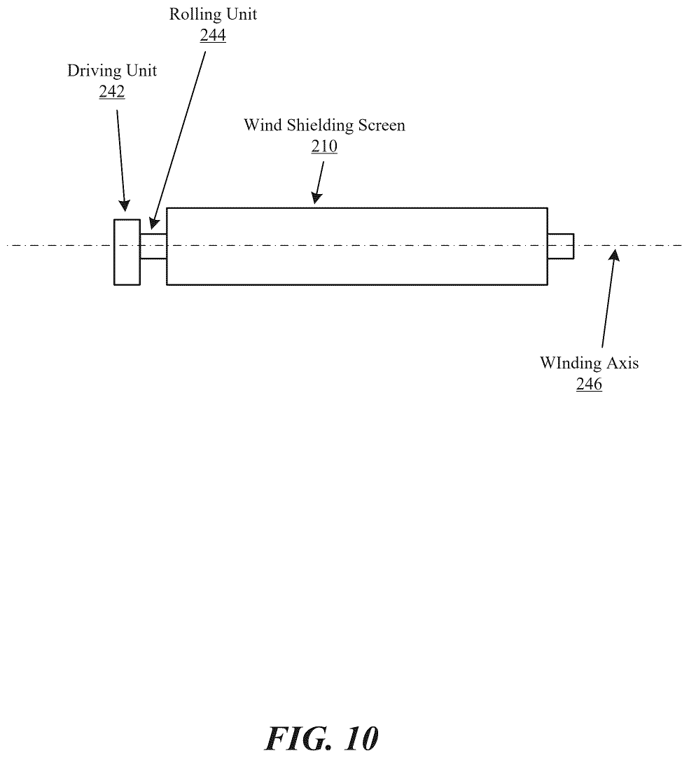

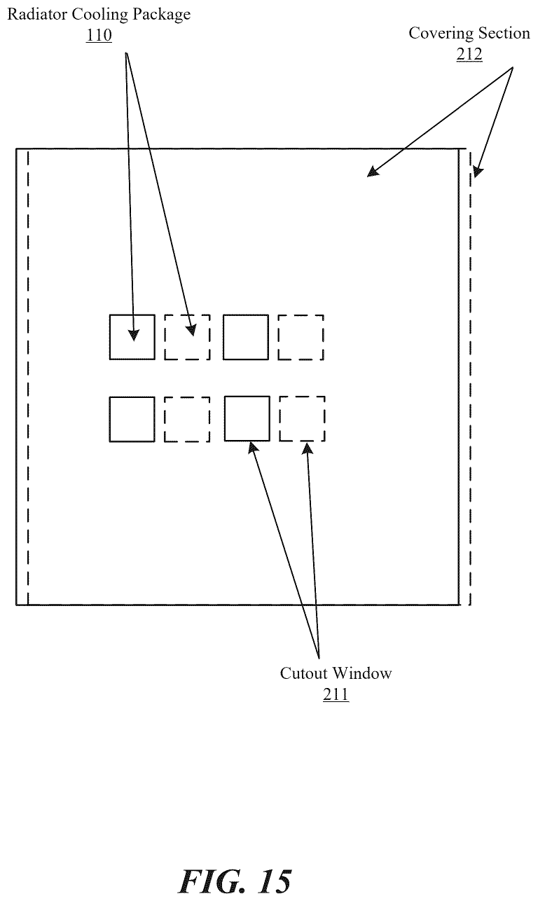

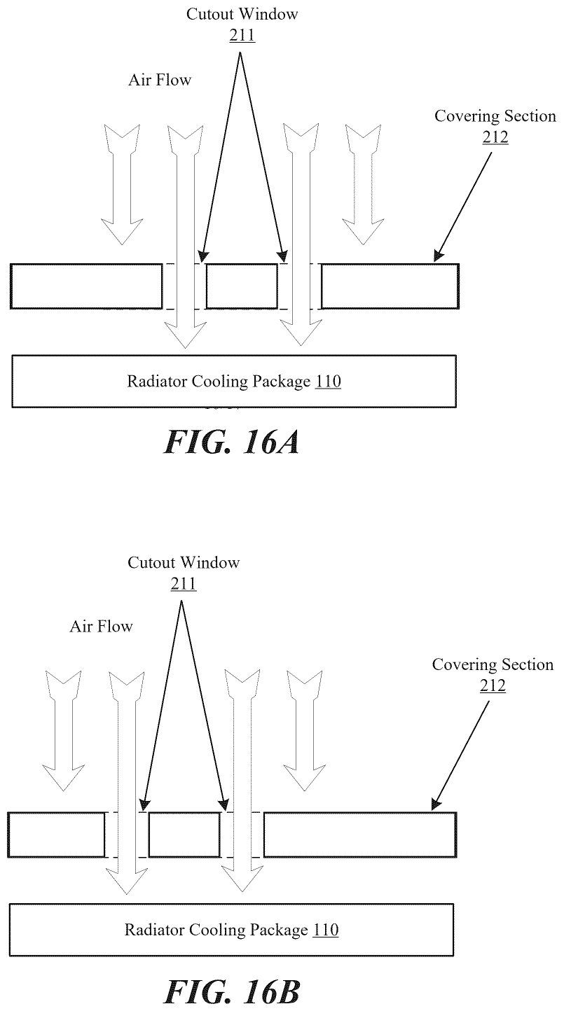

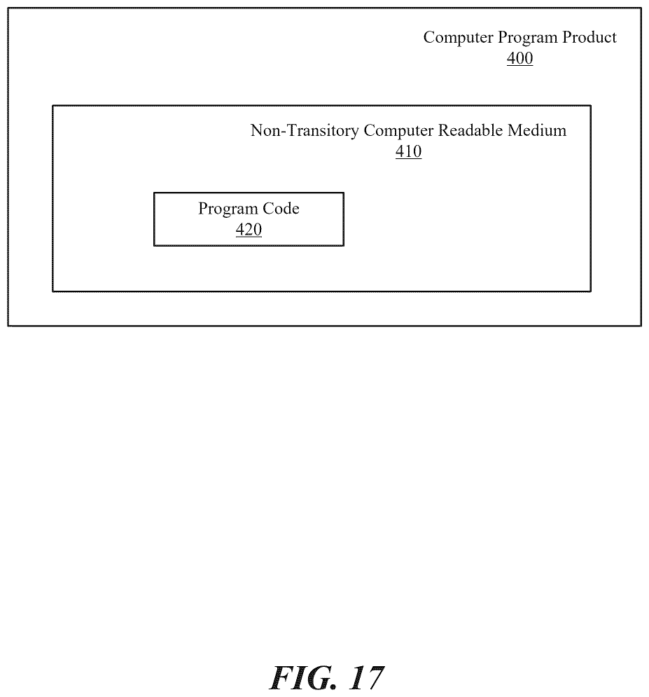

FIG. 1 is a schematic diagram illustrating components of a vehicle 100 capable of regulating an amount of airflow according to some embodiments of inventive concepts. In particular, as shown in FIG. 1, the vehicle 100 may comprise a radiator cooling package 110 and a wind shielding system 200. In some embodiments, the radiator cooling package 110 may comprise a radiator 112, a condenser 114, an insect screen 116, and a grill 118. In some embodiments, the wind shielding system 200 may comprise a wind shielding screen 210, an electronic control unit (ECU) 220, a temperature sensor 230, a barometric pressure sensor 260, an actuator 240 with a driving unit 242 and a rolling unit 244, and a power supply 250. FIGS. 2-9 are schematic diagrams illustrating that the wind shielding screen 210 may be used to impede an airflow from flowing to or allow the airflow to flow to components of the radiator cooling package 110 according to some embodiments of inventive concepts. FIGS. 10-14 are schematic diagrams illustrating that the wind shielding screen 210 may be wound onto or unwound from the rolling unit 244 which may be moved and rotated by the driving unit 242 according to some embodiments of inventive concepts. FIGS. 15 and 16A-16B are schematic diagrams illustrating that the wind shielding screen 210 may comprise a cutout window 211 for exposing different portions of the radiator cooling package 110 by shifting along with movement of the wind shielding screen 210 according to some embodiments of inventive concepts. FIG. 17 is a schematic diagram illustrating a computer program product 400 capable of regulating the amount of airflow according to some embodiments of inventive concepts. In particular, as shown in FIG. 17, the computer program product 400 may comprise a non-transitory computer readable medium 410 and a program code 420. The program code 420 may be executed by the wind shielding system 200 for regulating the amount of airflow to the radiator cooling package 110. In the following discussion, the operations of FIGS. 2-17 will be described with additional reference to FIG. 1. Like numbers in the figures refer to like operations.

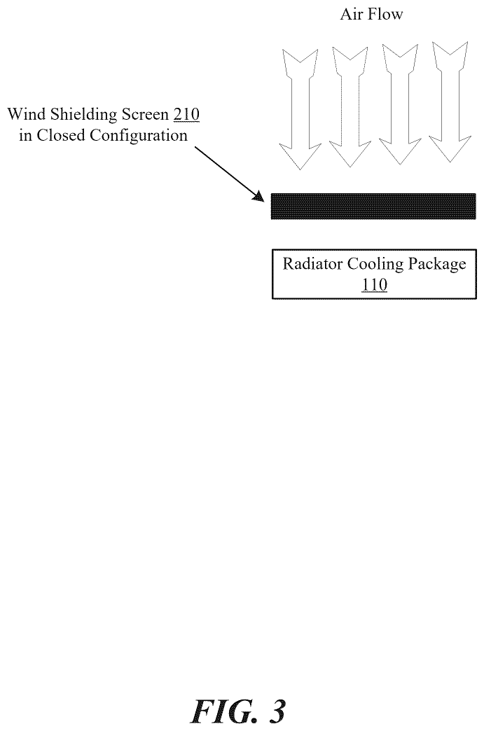

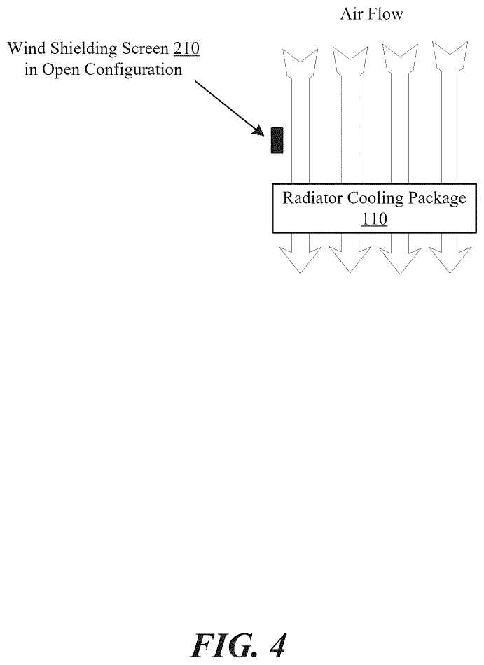

Referring now to FIG. 1, a wind shielding system 200 is provided to regulate an amount of airflow, such as a ram airflow, to a radiator cooling package 110 of a vehicle 100. According to some embodiments of inventive concepts, the wind shielding system 200 may comprise a wind shielding screen 210, an electronic control unit (ECU) 220, a temperature sensor 230, a barometric pressure sensor 260, an actuator 240, a power supply 250. Preferably, the wind shielding screen 210 may comprise a water-resistant material, a water-proof material, and/or a flexible material. For instance, the wind shielding screen 210 may be a fabric sheet with a hydrophobic coating. The wind shielding screen 210 may be configured to be adjacently located adjacent to the radiator cooling package 110, as shown in FIG. 2. For example, the wind shielding screen 210 may be configured to be located in front of the radiator cooling package 110. The temperature sensor 230, the barometric pressure sensor 260 and the actuator 240 may be each electrically coupled with the ECU 220, such that the ECU 220 may receive data from and send comments to the temperature sensor 230, the barometric pressure sensor 260 and the actuator 240. The power supply 250 may be electrically coupled with the ECU 220, the temperature sensor 230, the barometric pressure sensor 260 and the actuator 240 so as to provide power to the ECU 220, the temperature sensor 230, the barometric pressure sensor 260 and the actuator 240. The power supply 250 may be, for instance, a DC battery, or a power system mounted in the vehicle 100. Specifically, the temperature sensor 230 may be configured to detect an air temperature of an ambient air surrounding the radiator cooling package 110. For instance, the temperature sensor 230 may detect a temperature of ram air flowing to the radiator cooling package 110 when the vehicle 100 is moving or running. Furthermore, the barometric pressure sensor 260 may be configured to detect a barometric pressure of the ambient air. For instance, the barometric pressure sensor 260 may detect a barometric pressure of the ram air flowing to the radiator cooling package 110. Additionally, the temperature sensor 230 may be configured to further detect a component temperature of a component associated with the radiator cooling package 110, such as a coolant. Thereafter, the ECU 220 may be configured to perform calibration of the detected air temperature, the detected barometric pressure and/or the detected component temperature. In other words, the ECU 220 may make a determination according to the detected air temperature, the detected barometric pressure and/or the detected component temperature. The actuator 240 may be operatively coupled with the wind shielding screen 210 and may be controllable by the ECU 220 to move the wind shielding screen 210 between a closed configuration, as shown in FIG. 3, and an open configuration, as shown in FIG. 4, with respect to the radiator cooling package 110 based on the detected air temperature, the detected barometric pressure and/or the detected component temperature, specifically, based on the calibration of or the determination according to the detected air temperature, the detected barometric pressure and/or the detected component temperature. An automated process may thus be achieved via the ECU 220 and the actuator 240. For example, when the ECU 220 determines that ice may become formed on the radiator cooling package 110 from an airflow at the detected air temperature (probably under the detected barometric pressure), and may additionally determine that the component associated with the radiator cooling package 110 may become frozen at the detected component temperature, the ECU 220 may then control the actuator 240 to move the wind shielding screen 210 to the closed configuration. Accordingly, the wind shielding screen 210 may be configured to at least partially cover the radiator cooling package 110 and thus to at least partially impede an airflow, such as a cold ram airflow in winter, from flowing to the radiator cooling package 110 in the closed configuration, as shown in FIG. 3. Using the wind shielding screen 210 which comprises the water-resistant material or the water-proof material to at least partially cover the radiator cooling package 110 may thus impede from thick ice deposition and formation on the radiator cooling package 110 from the airflow, as well as impeding the component associated with the radiator cooling package 110 from becoming frozen due to the airflow decreasing the component temperature, during a cold weather (it is known that the freezing point of water is around 0° C. or 32° F. at around 1 atm pressure, and that a coolant may be frozen at a very low temperature), thereby achieving better cooling performance of the radiator cooling package 110, increasing usage life of the radiator cooling package 110, decreasing maintenance cost, avoiding corrosion and rust of the radiator cooling package 110 due to low temperature, quick heat-up of an engine, quick warming-up of a cab, better fuel efficiency, and better energy management, for electric vehicles, or hydrogen vehicles. Alternatively, when the ECU 220 determines that ice may not become formed on the radiator cooling package 110 from an airflow at the detected air temperature (probably under the detected barometric pressure), and may additionally determine that the component associated with the radiator cooling package 110 may become burned at the detected component temperature, the ECU 220 may then control the actuator 240 to move the wind shielding screen 210 to the open configuration. Accordingly, the wind shielding screen 210 may be configured to expose the radiator cooling package 110 and thus to allow the airflow to flow to the radiator cooling package 110 in the open configuration, as shown in FIG. 4. For example, at high ambient temperature conditions, the component associated with the radiator cooling package 110 may become burned due to lacking an airflow decreasing the component temperature. Therefore, the wind shielding screen 210 in the open configuration renders the radiator cooling package 110 exposed, and thus the airflow flowing to the radiator cooling package 110 may contribute to cooling efficiency of the radiator cooling package 110 as well as the engine, thereby increasing fuel saving, and reducing carbon dioxide emission.

According to some embodiments of inventive concepts, in the wind shielding system 200, when the calibration is performed or the determination is made by the ECU 220, the ECU 220 determines that the detected air temperature of the ambient air surrounding the radiator cooling package 110 at the detected barometric pressure is less than a predetermined threshold, for instance, around 5 degrees Celsius (around 41 degrees Fahrenheit) and may additionally determine that when the detected barometric pressure is around 1 atm (i.e., 100 kPa or 1 bar) (i.e., the ECU 220 determines that the detected air temperature at the detected barometric pressure might be low enough for ice formation), the actuator 240 may be controllable by the ECU 220 to move the wind shielding screen 210 to the closed configuration, as shown in FIG. 3. Additionally, when the ECU 220 determines that the detected air temperature of the ambient air surrounding the radiator cooling package 110 at the detected barometric pressure is larger than a predetermined threshold (for instance, the ECU 220 determines that the detected air temperature at the detected barometric pressure might not be low enough for ice formation), the actuator 240 may be controllable by the ECU 220 to move the wind shielding screen 210 to the open configuration, as shown in FIG. 4.

According to some embodiments of inventive concepts, in the wind shielding system 200, when the calibration is performed by or the determination is made by the ECU 220, the ECU 220 determines that the detected component temperature of the component associated with the radiator cooling package 110 is larger than a predetermined threshold (i.e., the ECU 220 determines that the detected component temperature is too high, and that the component might be burned dues to such high component temperature), the actuator 240 may be controllable by the ECU 220 to move the wind shielding screen 210 to the open configuration, as shown in FIG. 4. Therefore, the airflow flowing to the radiator cooling package 110 may decrease the component temperature of the component. Additionally, when the ECU 220 determines that the component temperature of the component is less than a predetermined threshold, and that there is a risk that the component may be frozen due to a very low temperature, the actuator 240 may be controllable by the ECU 220 to move the wind shielding screen 210 to the closed configuration, as shown in FIG. 3. Therefore, the component temperature of the component may not be decreased since the airflow is impeded from flowing to the radiator cooling package 110.

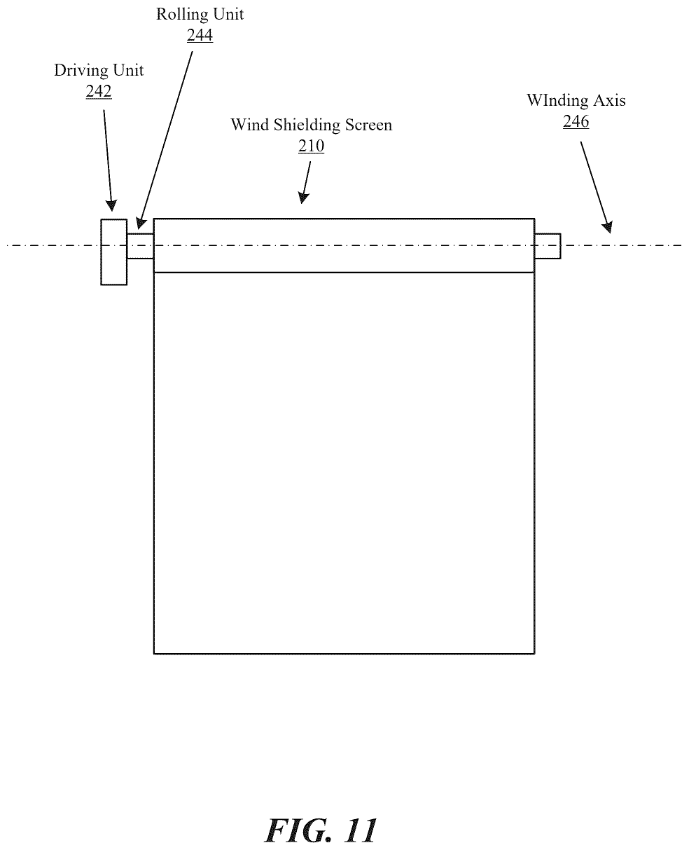

Reference now is made to FIGS. 10-11, according to some embodiments, in the wind shielding system 200, the actuator 240 may comprise a driving unit 242 and a rolling unit 244. The driving unit 242 may be electrically coupled with the ECU 220, as shown in FIG. 1. The rolling unit 244 may be engaged with the driving unit 242, while the wind shielding screen 210 may be windably attached to the rolling unit 244. Therefore, the driving unit 242 may be controllable by the ECU 220 to rotate the rolling unit 244 in a clockwise direction or a counterclockwise direction around a winding axis 246 of the rolling unit 244 so as to wind or unwind the wind shielding screen 210. Preferably, the driving unit 242 may be engaged with a left end of the rolling unit 244 while the rolling unit 244 is attached to an upper side of the wind shielding screen 210, as shown in FIG. 11. Additionally, another rolling unit or a supporting unit may be attached to a lower side of the wind shielding screen 210 (not shown). Optionally, another driving unit or a track unit may be engaged with a right end of the rolling unit 244 (not shown). Alternatively, the driving unit 242 may be engaged with an upper end or a lower end of the rolling unit 244 while the rolling unit 244 is attached to a left side or a right side of the wind shielding screen 210; Similarly, another rolling unit or a supporting unit and another driving unit or a track unit may be used (not shown).

As illustrated in FIG. 11, according to some embodiments, in the wind shielding system 200, when the wind shielding screen 210 is unwound from the rolling unit 244, the wind shielding screen 210 may be moved towards the closed configuration. As illustrated in FIG. 10, according to some embodiments, in the wind shielding system 200, when the wind shielding screen 210 is wound onto the rolling unit 244, the wind shielding screen 210 may be moved towards the open configuration.

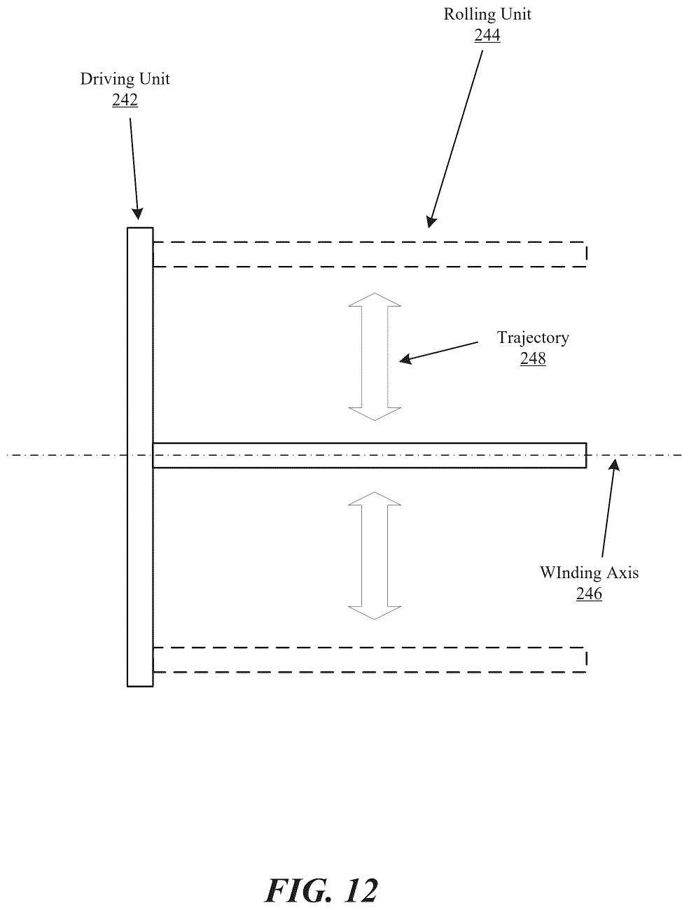

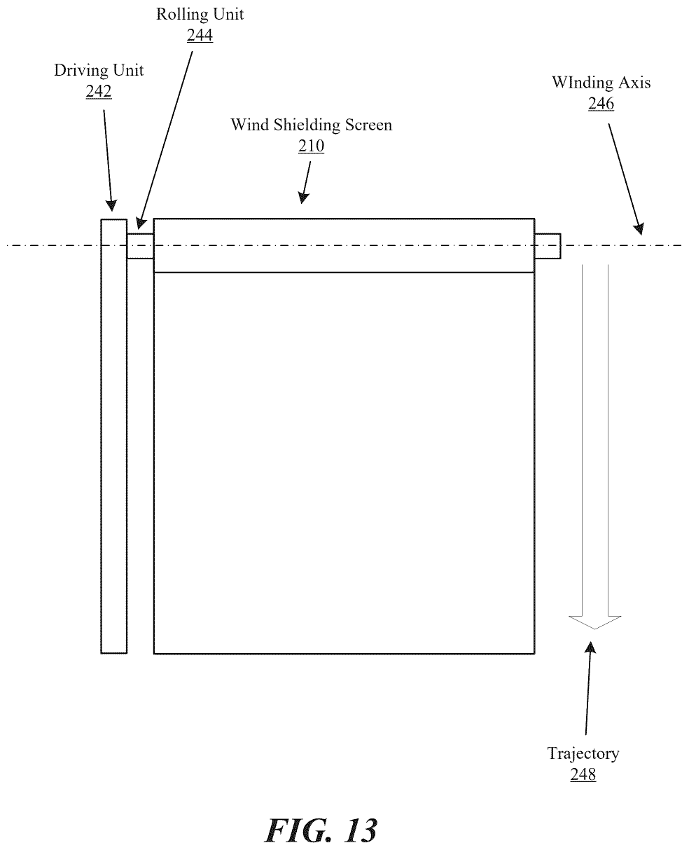

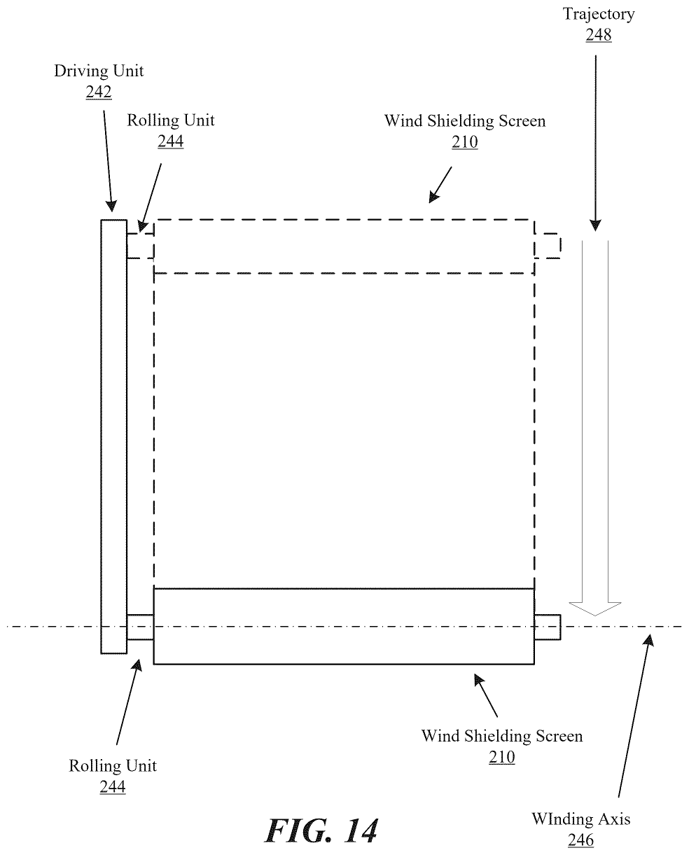

As illustrated in FIGS. 12-14, according to some embodiments, in the wind shielding system 200, the driving unit 242 may be controllable by the ECU 220 to move the rolling unit 244 along a trajectory 248 substantially perpendicular to the winding axis 246. For example, as shown in FIG. 13, the wind shielding screen 210 is initially in the closed configuration, the driving unit 242 may be controllable by the ECU 220 to move the rolling unit 244 from an upper position of the trajectory 248 and to rotate the rolling unit 244 around the winding axis 246. Thereafter, when the rolling unit 244 moves to a lower position of the trajectory 248, the wind shielding screen 210 is wound onto the rolling unit 244 and is thus moved to the open configuration, as shown in FIG. 14. The rotation and translation movement of the rolling unit 244 may be, for instance, achieved via rotation movement of the driving unit 242: the driving unit 242 and the rolling unit 244 each has helical portions engaged with each other.

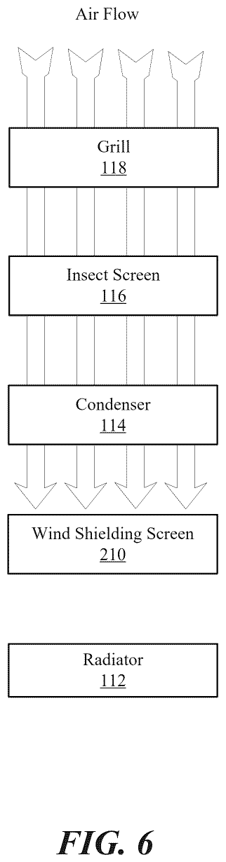

As can be seen in FIG. 6, according to some embodiments, the radiator cooling package 110 may comprise a radiator 112, the wind shielding screen 210 may be configured to be adjacently located adjacent to, such as in front of, the radiator 112. Specifically, the actuator 240 may be controllable by the ECU 220 to move the wind shielding screen 210 between the closed configuration and the open configuration with respect to the radiator 112. When the wind shielding screen 210 is in the closed configuration, the wind shielding screen 210 may be configured to at least partially cover the radiator 112 and thus to at least partially impede the airflow from flowing to the radiator 112, as shown in FIG. 6. Accordingly, ice formation on the radiator 112, as well as a frozen component associated with the radiator cooling package 110, may be avoided. On the other hand, when the wind shielding screen 210 is in the open configuration, the wind shielding screen 210 may be configured to expose the radiator 112 and thus to allow the airflow to flow to the radiator 112 (not shown). Accordingly, a burned component associated with the radiator cooling package 110 may be avoided.

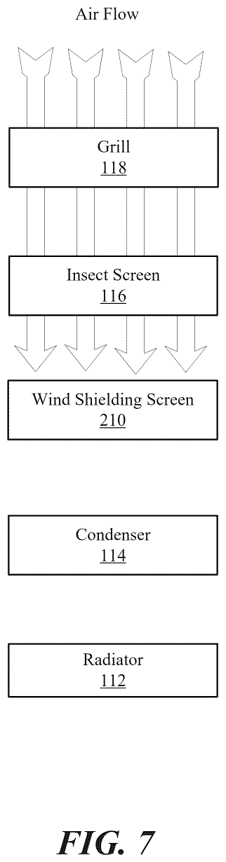

As can be seen in FIG. 7, according to some embodiments, the radiator cooling package 110 may further comprise a condenser 114. Alternatively, in the wind shielding system 200, the wind shielding screen 210 may be configured to be adjacently located adjacent to, such as in front of, the condenser 114. Similarly, the actuator 240 may be controllable by the ECU 220 to move the wind shielding screen 210 between the closed configuration and the open configuration with respect to the condenser 114. When the wind shielding screen 210 is in the closed configuration, the wind shielding screen 210 may be configured to at least partially cover the condenser 114 as well as the radiator 112 and thus to at least partially impede the airflow from flowing to both of the condenser 114 and the radiator 112. Accordingly, ice formation on the condenser 114 may further be avoided. On the other hand, when the wind shielding screen 210 is in the open configuration, the wind shielding screen 210 may be configured to expose the condenser 114 as well as the radiator 112 and thus to allow the airflow to flow to both of the condenser 114 and the radiator 112 (not shown).

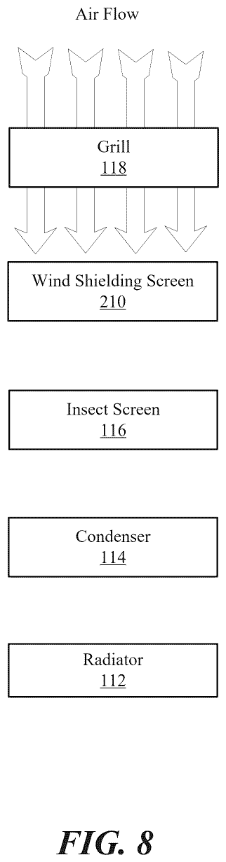

As can be seen in FIG. 8, according to some embodiments, the radiator cooling package 110 may further comprise an insect screen 116. Alternatively, in the wind shielding system 200, the wind shielding screen 210 may be configured to be adjacently located adjacent to, such as in front of, the insect screen 116. Similarly, the actuator 240 may be controllable by the ECU 220 to move the wind shielding screen 210 between the closed configuration and the open configuration with respect to the insect screen 116. When the wind shielding screen 210 is in the closed configuration, the wind shielding screen 210 may be configured to at least partially cover the insect screen 116 as well as the condenser 114 and the radiator 112 and thus to at least partially impede the airflow from flowing to all of the insect screen 116, the condenser 114 and the radiator 112. Accordingly, ice formation on the insect screen 116 may further be avoided. On the other hand, when the wind shielding screen 210 is in the open configuration, the wind shielding screen 210 may be configured to expose the insect screen 116 as well as the condenser 114 and the radiator 112 and thus to allow the airflow to flow to all of the insect screen 116, the condenser 114 and the radiator 112 (not shown).

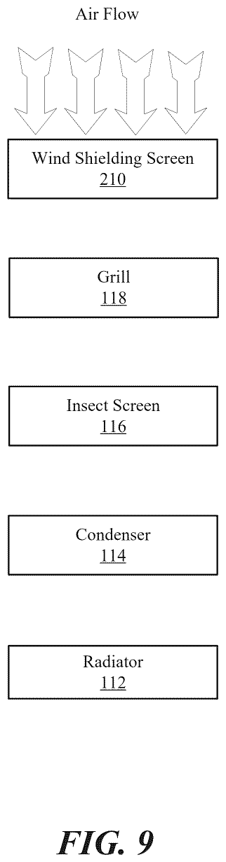

As can be seen in FIG. 9, according to some embodiments, the radiator cooling package 110 may further comprise a grill 118. Alternatively, in the wind shielding system 200, the wind shielding screen 210 may be configured to be adjacently located adjacent to, such as in front of, the grill 118. Similarly, the actuator 240 may be controllable by the ECU 220 to move the wind shielding screen 210 between the closed configuration and the open configuration with respect to the grill 118. When the wind shielding screen 210 is in the closed configuration, the wind shielding screen 210 may be configured to at least partially cover the grill 118 as well as the insect screen 116, the condenser 114 and the radiator 112 and thus to at least partially impede the airflow from flowing to all of the grill 118, the insect screen 116, the condenser 114 and the radiator 112. Accordingly, ice formation on the grill 118 may further be avoided. On the other hand, when the wind shielding screen 210 is in the open configuration, the wind shielding screen 210 may be configured to expose the grill 118 as well as the insect screen 116, the condenser 114 and the radiator 112 and thus to allow the airflow to flow to all of the grill 118, the insect screen 116, the condenser 114 and the radiator 112 (not shown).

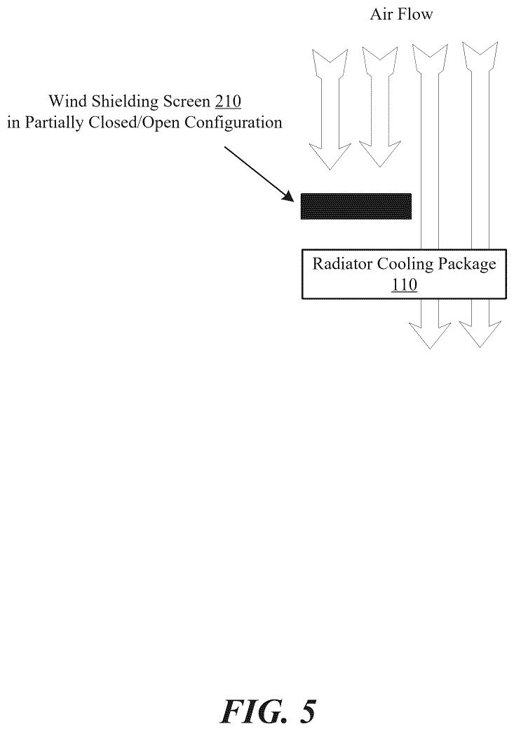

Additionally, according to some embodiments, in the wind shielding system 200, the actuator 240 may be further controllable by the ECU 220 to move the wind shielding screen 210 between the closed configuration, a partially closed/open configuration and the open configuration with respect to the radiator cooling package 110 based on the calibration, as shown in FIG. 5. Accordingly, the wind shielding screen 210 may be further configured to partially cover or partially expose the radiator cooling package 110. Thus, when the wind shielding screen 210 is in the partially closed/open configuration, the wind shielding screen 210 may be further configured to partially impede the airflow from flowing to the radiator cooling package 110 while may be further configured to partially allow the airflow to flow to the radiator cooling package 110. For example, according to some embodiments, in the wind shielding system 200, when the ECU 220 performs the calibration or makes the determination, the ECU 220 determines that the detected air temperature of the ambient air surrounding the radiator cooling package 110 at the detected barometric pressure is less than a predetermined threshold at which ice may be formed and that the detected component temperature of the component associated with the radiator cooling package 110 is larger than another predetermined threshold at which the component may be burned (i.e., the ECU 220 determines that the detected air temperature of the ambient air surrounding the radiator cooling package 110 at the detected barometric pressure is too low while the detected component temperature of the component associated with the radiator cooling package 110 is too high), the actuator 240 may be controllable by the ECU 220 to move the wind shielding screen 210 to the partially closed/open configuration. Accordingly, it may decrease the ice formation rate while at the same time helping decrease the component temperature.

According to some embodiments, in the wind shielding system 200, the temperature sensor 230 may comprise at least one of an A/C fallback mode temperature sensor, a coolant temperature sensor, an ambient air temperature sensor, a boost temperature sensor, and a retarder temperature sensor, etc. Therefore, the ECU 220 may perform the calibration or make the determination based on different temperatures detected by the A/C fallback mode temperature sensor, the coolant temperature sensor, the ambient air temperature sensor, the boost temperature sensor and the retarder temperature sensor. For example, the component associated with the radiator cooling package 110 may comprise coolant flowing through the radiator cooling package 110, and the temperature sensor 230 may comprise the coolant temperature sensor for detecting the temperature of the coolant.

Reference now is made to FIGS. 15 and 16A-16B. According to some embodiments, in the wind shielding system 200, the wind shielding screen 210 may comprise a covering section 212 and a cutout window 211 formed thereon, the covering section 212 may be configured to impede an airflow to pass therethrough, while the cutout window 211 may be configured to allow a small amount of airflow to pass therethrough, compared to a wind shielding screen without cutout windows. The cutout window 211 and the covering section 212 may be beneficial in circumstances that avoiding ice formation on the radiator cooling package 110 is needed while maintaining cooling efficiency of the radiator cooling package 110 is also needed. Specifically, as illustrated in FIG. 15, the covering section 212 of the wind shielding screen 210 may be configured to cover a portion of the radiator cooling package 110 while the cutout window 211 of the wind shielding screen 210 may be configured to expose another portion of the radiator cooling package 110. When the wind shielding screen 210 moves with respect to the radiator cooling package 110, the cutout window 211 is shifted along with movement of the wind shielding screen 210. Then, the covering section 212 may be configured to cover the another portion of the radiator cooling package 110 which was exposed by the cutout window 211 before the cutout window 211 is shifted. Before the cutout window 211 is shifted, as illustrated in FIG. 16A, the cutout window 211 may allow the airflow to pass therethrough and to flow to a portion of the radiator cooling package 110. After the cutout window 211 is shifted, as illustrated in FIG. 16B, the cutout window 211 may allow the airflow to pass therethrough and to flow to another portion of the radiator cooling package 110. Therefore, if unfortunately ice is formed on an exposed portion of the radiator cooling package 110, the cutout window 211 that initially exposed the exposed portion of the radiator cooling package 110 may be shifted away, such that the initially exposed portion of the radiator cooling package 110 may be covered by the covering section 212, thereby avoiding further ice formation or even benefiting ice melting.

A vehicle 100 is also provided, referring now back to FIG. 1. According to some embodiments of inventive concepts, the vehicle 100 may comprise a radiator cooling package 110 and the previously mentioned wind shielding system 200. The wind shielding system 200 may be configured for regulating an amount of airflow to the radiator cooling package 110. As previously mentioned, the wind shielding system 200 may comprises a wind shielding screen 210, an electronic control unit (ECU) 220, a temperature sensor 230, a barometric pressure sensor 260, and an actuator 240. The wind shielding screen 210 may be located adjacent to the radiator cooling package 110 (as shown in FIG. 2), the temperature sensor 230, the barometric pressure sensor 260 and the actuator 240 may be each electrically coupled with the ECU 220, the temperature sensor 230 may be configured to detect an air temperature of an ambient air surrounding the radiator cooling package 110 and a component temperature of a component associated with the radiator cooling package 110, the barometric pressure sensor 260 may be configured to detect a barometric pressure of the ambient air, the ECU 220 may be configured to perform calibration of the detected air temperature, the detected barometric pressure and/or the detected component temperature, the actuator 240 may be operatively coupled with the wind shielding screen 210 and may be controllable by the ECU 220 to move the wind shielding screen 210 between a closed configuration and an open configuration with respect to the radiator cooling package 110 based on the detected air temperature, the detected barometric pressure and/or the detected component temperature, specifically, based on the calibration of the detected air temperature, the detected barometric pressure and/or the detected component temperature, and the wind shielding screen 210 may at least partially cover the radiator cooling package 110 and thus may be configured to at least partially impede an airflow from flowing to the radiator cooling package 110 in the closed configuration (as shown in FIG. 3) and may expose the radiator cooling package 110 and thus may be configured to allow the airflow to flow to the radiator cooling package 110 in the open configuration (as shown in FIG. 4).

According to some embodiments of inventive concepts, in the vehicle 100, as previously mentioned, for instance, the actuator 240 may be controllable by the ECU 220 to move the wind shielding screen 210 to the closed configuration in response to subsequent to the calibration the ECU 220 determining that the detected air temperature of the ambient air surrounding the radiator cooling package 110 at the detected barometric pressure is less than a predetermined threshold based on the calibration.

According to some embodiments of inventive concepts, in the vehicle 100, as previously mentioned, for instance, the actuator 240 may be controllable by the ECU 220 to move the wind shielding screen 210 to the open configuration in response to subsequent to the calibration the ECU 220 determining that the detected component temperature of the component associated with the radiator cooling package 110 is larger than a predetermined threshold based on the calibration.

According to some embodiments of inventive concepts, in the vehicle 100, as previously mentioned, as shown in FIGS. 10-11, the actuator 240 may comprise a driving unit 242 and a rolling unit 244, the driving unit 242 may be electrically coupled with the ECU 220, the rolling unit 244 may be engaged with the driving unit 242, the wind shielding screen 210 may be windably attached to the rolling unit 244, and the driving unit 242 may be controllable by the ECU 220 to rotate the rolling unit 244 around a winding axis 246 of the rolling unit 244 so as to wind or unwind the wind shielding screen 210.

According to some embodiments of inventive concepts, in the vehicle 100, as previously mentioned, the wind shielding screen 210 may be moved towards the closed configuration in response to the wind shielding screen 210 being unwound from the rolling unit 244 (as shown in FIG. 11), and the wind shielding screen 210 may be moved towards the open configuration in response to the wind shielding screen 210 being wound onto the rolling unit 244 (as shown in FIG. 10).

According to some embodiments of inventive concepts, in the vehicle 100, as previously mentioned, as shown in FIGS. 12-14, the driving unit 242 may be controllable by the ECU 220 to move the rolling unit 244 along a trajectory 248 substantially perpendicular to the winding axis 246.

According to some embodiments of inventive concepts, in the vehicle 100, as previously mentioned, as shown in FIG. 6, the radiator cooling package 110 may comprise a radiator 112, the wind shielding screen 210 may be located adjacent to the radiator 112, the actuator 240 may be controllable by the ECU 220 to move the wind shielding screen 210 between the closed configuration and the open configuration with respect to the radiator 112, and the wind shielding screen 210 may at least partially cover the radiator 112 and thus may be configured to at least partially impede the airflow from flowing to the radiator 112 in the closed configuration and may expose the radiator 112 and thus may be configured to allow the airflow to flow to the radiator 112 in the open configuration.

According to some embodiments of inventive concepts, in the vehicle 100, as previously mentioned, as shown in FIG. 7, the radiator cooling package 110 may comprise a condenser 114, the wind shielding screen 210 may be located adjacent to the condenser 114, the actuator 240 may be controllable by the ECU 220 to move the wind shielding screen 210 between the closed configuration and the open configuration with respect to the condenser 114, and the wind shielding screen 210 may at least partially cover the condenser 114 and thus may be configured to at least partially impede the airflow from flowing to the condenser 114 in the closed configuration and may expose the condenser 114 and thus may be configured to allow the airflow to flow to the condenser 114 in the open configuration.

According to some embodiments of inventive concepts, in the vehicle 100, as previously mentioned, as shown in FIG. 8, the radiator cooling package 110 may comprise an insect screen 116, the wind shielding screen 210 may be located adjacent to the insect screen 116, the actuator 240 may be controllable by the ECU 220 to move the wind shielding screen 210 between the closed configuration and the open configuration with respect to the insect screen 116, and the wind shielding screen 210 may at least partially cover the insect screen 116 and thus may be configured to at least partially impede the airflow from flowing to the insect screen 116 in the closed configuration and may expose the insect screen 116 and thus may be configured to allow the airflow to flow to the insect screen 116 in the open configuration.

According to some embodiments of inventive concepts, in the vehicle 100, as previously mentioned, as shown in FIG. 9, the radiator cooling package 110 may comprise a grill 118, the wind shielding screen 210 may be located adjacent to the grill 118, the actuator 240 may be controllable by the ECU 220 to move the wind shielding screen 210 between the closed configuration and the open configuration with respect to the grill 118, and the wind shielding screen 210 may at least partially cover the grill 118 and thus may be configured to at least partially impede the airflow from flowing to the grill 118 in the closed configuration and may expose the grill 118 and thus may be configured to allow the airflow to flow to the grill 118 in the open configuration.

According to some embodiments of inventive concepts, in the vehicle 100, as previously mentioned, as shown in FIG. 5, the actuator 240 may be controllable by the ECU 220 to move the wind shielding screen 210 between the closed configuration, a partially closed/open configuration and the open configuration with respect to the radiator cooling package 110 based on the calibration, and the wind shielding screen 210 may partially cover or partially expose the radiator cooling package 110 and thus may be configured to partially impede the airflow from flowing to while to partially allow the airflow to flow to the radiator cooling package 110 in the partially closed/open configuration. For example, as previously mentioned, the actuator 240 may be controllable by the ECU 220 to move the wind shielding screen 210 to the partially closed/open configuration in response to subsequent to the calibration the ECU 220 determining that the detected air temperature of the ambient air surrounding the radiator cooling package 110 at the detected barometric pressure is less than a predetermined threshold and that the detected component temperature of the component associated with the radiator cooling package 110 is larger than another predetermined threshold.

According to some embodiments of inventive concepts, in the vehicle 100, as previously mentioned, as shown in FIG. 1, the wind shielding system 200 may comprise a power supply 250. The power supply 250 may be electrically coupled with the ECU 220, the temperature sensor 230, the barometric pressure sensor 260 and the actuator 240.

According to some embodiments of inventive concepts, in the vehicle 100, as previously mentioned, the wind shielding screen 210 may comprise a water-resistant material, a water-proof material, and/or a flexible material.

According to some embodiments of inventive concepts, in the vehicle 100, as previously mentioned, the temperature sensor 230 may comprise at least one of an A/C fallback mode temperature sensor, a coolant temperature sensor, an ambient air temperature sensor, a boost temperature sensor, and a retarder temperature sensor.

According to some embodiments of inventive concepts, in the vehicle 100, as previously mentioned, the component associated with the radiator cooling package 110 may comprise coolant flowing through the radiator cooling package 110.

According to some embodiments of inventive concepts, in the vehicle 100, as previously mentioned, as shown in FIGS. 15-16, the wind shielding screen 210 may comprise a covering section 212 and a cutout window 211 formed thereon, the covering section 212 may be configured to impede the airflow to pass therethrough, and the cutout window 211 may be configured to allow the airflow to pass therethrough.

A wind shielding method is also provided to regulate the amount of airflow to the radiator cooling package 110 of the above recited vehicle 100 by the above recited wind shielding system 200. The wind shielding method is described with reference to FIGS. 1-16. According to some embodiments of inventive concepts, the wind shielding method may comprise: locating a wind shielding screen 210 of the wind shielding system 200 to the radiator cooling package 110; electrically coupled each of a temperature sensor 230, a barometric pressure sensor 260 and an actuator 240 of the wind shielding system 200 with an electronic control unit (ECU) 220 of the wind shielding system 200; detecting an air temperature of an ambient air surrounding the radiator cooling package 110 and a component temperature of a component associated with the radiator cooling package 110 by the temperature sensor 230; detecting a barometric pressure of the ambient air by the barometric pressure sensor 260; performing calibration of the detected air temperature, the detected barometric pressure and/or the detected component temperature by the ECU 220; operatively coupling the actuator 240 with the wind shielding screen 210; controlling the actuator 240 by the ECU 220 to move the wind shielding screen 210 between a closed configuration and an open configuration with respect to the radiator cooling package 110 based on the calibration; at least partially covering the radiator cooling package 110 and thus at least partially impeding an airflow from flowing to the radiator cooling package 110 via the wind shielding screen 210 by moving the wind shielding screen 210 to the closed configuration; and exposing the radiator cooling package 110 and thus allowing the airflow to flow to the radiator cooling package 110 via the wind shielding screen 210 by moving the wind shielding screen 210 to the open configuration.

According to some embodiments of inventive concepts, the wind shielding method may further comprise controlling the actuator 240 by the ECU 220 to move the wind shielding screen 210 to the closed configuration in response to subsequent to the calibration the ECU 220 determining that the detected air temperature of the ambient air surrounding the radiator cooling package 110 at the detected barometric pressure is less than a predetermined threshold based on the calibration.

According to some embodiments of inventive concepts, the wind shielding method may further comprise controlling the actuator 240 by the ECU 220 to move the wind shielding screen 210 to the open configuration in response to subsequent to the calibration the ECU 220 determining that the detected component temperature of the component associated with the radiator cooling package 110 is larger than a predetermined threshold based on the calibration.

According to some embodiments of inventive concepts, the wind shielding method may further comprise: electrically coupling a driving unit 242 of the actuator 240 with the ECU 220; engaging a rolling unit 244 of the actuator 240 with the driving unit 242; windably attaching the wind shielding screen 210 to the rolling unit 244; and controlling the driving unit 242 by the ECU 220 to rotate the rolling unit 244 around a winding axis 246 of the rolling unit 244 so as to wind or unwind the wind shielding screen 210. According to some embodiments of inventive concepts, the wind shielding method

may further comprise moving the wind shielding screen 210 towards the closed configuration by unwinding the wind shielding screen 210 from the rolling unit 244; and moving the wind shielding screen 210 towards the open configuration by winding the wind shielding screen 210 onto the rolling unit 244.

According to some embodiments of inventive concepts, the wind shielding method may further comprise controlling the driving unit 242 by the ECU 220 to move the rolling unit 244 along a trajectory 248 substantially perpendicular to the winding axis 246.

According to some embodiments of inventive concepts, the wind shielding method may further comprise: locating the wind shielding screen 210 to a radiator 112 of the radiator cooling package 110; controlling the actuator 240 by the ECU 220 to move the wind shielding screen 210 between the closed configuration and the open configuration with respect to the radiator 112; at least partially covering the radiator 112 and thus at least partially impeding the airflow from flowing to the radiator 112 via the wind shielding screen 210 by moving the wind shielding screen 210 to the closed configuration; and exposing the radiator 112 and thus allowing the airflow to flow to the radiator 112 via the wind shielding screen 210 by moving the wind shielding screen 210 to the open configuration.

According to some embodiments of inventive concepts, the wind shielding method may further comprise: locating the wind shielding screen 210 to a condenser 114 of the radiator cooling package 110; controlling the actuator 240 by the ECU 220 to move the wind shielding screen 210 between the closed configuration and the open configuration with respect to the condenser 114; at least partially covering the condenser 114 and thus at least partially impeding the airflow from flowing to the condenser 114 via the wind shielding screen 210 by moving the wind shielding screen 210 to the closed configuration; and exposing the condenser 114 and thus allowing the airflow to flow to the condenser 114 via the wind shielding screen 210 by moving the wind shielding screen 210 to the open configuration.

According to some embodiments of inventive concepts, the wind shielding method may further comprise: locating the wind shielding screen 210 to an insect screen 116 of the radiator cooling package 110; controlling the actuator 240 by the ECU 220 to move the wind shielding screen 210 between the closed configuration and the open configuration with respect to the insect screen 116; at least partially covering the insect screen 116 and thus at least partially impeding the airflow from flowing to the insect screen 116 via the wind shielding screen 210 by moving the wind shielding screen 210 to the closed configuration; and exposing the insect screen 116 and thus allowing the airflow to flow to the insect screen 116 via the wind shielding screen 210 by moving the wind shielding screen 210 to the open configuration.

According to some embodiments of inventive concepts, the wind shielding method may further comprise: locating the wind shielding screen 210 to a grill 118 of the radiator cooling package 110; controlling the actuator 240 by the ECU 220 to move the wind shielding screen 210 between the closed configuration and the open configuration with respect to the grill 118; at least partially covering the grill 118 and thus at least partially impeding the airflow from flowing to the grill 118 via the wind shielding screen 210 by moving the wind shielding screen 210 to the closed configuration; and exposing the grill 118 and thus allowing the airflow to flow to the grill 118 via the wind shielding screen 210 by moving the wind shielding screen 210 to the open configuration.

According to some embodiments of inventive concepts, the wind shielding method may further comprise: controlling the actuator 240 by the ECU 220 to move the wind shielding screen 210 between the closed configuration, a partially closed/open configuration and the open configuration with respect to the radiator cooling package 110 based on the calibration; and partially covering or partially exposing the radiator cooling package 110 and thus partially impeding the airflow from flowing to while partially allowing the airflow to flow to the radiator cooling package 110 via the wind shielding screen 210 by moving the wind shielding screen 210 to the partially closed/open configuration.

According to some embodiments of inventive concepts, the wind shielding method may further comprise: controlling the actuator 240 by the ECU 220 to move the wind shielding screen 210 to the partially closed/open configuration in response to subsequent to the calibration the ECU 220 determining that the detected air temperature of the ambient air surrounding the radiator cooling package 110 at the detected barometric pressure is less than a predetermined threshold and that the detected component temperature of the component associated with the radiator cooling package 110 is larger than another predetermined threshold.

According to some embodiments of inventive concepts, the wind shielding method may further comprise electrically coupled a power supply 250 of the wind shielding system 200 with the ECU 220, the temperature sensor 230 and the actuator 240.

According to some embodiments of inventive concepts, the wind shielding method may further comprise: covering a portion of the radiator cooling package 110 via a covering section 212 of the wind shielding screen 210 to impede the airflow from flowing to the portion of the radiator cooling package 110; and exposing another portion of the radiator cooling package 110 via a cutout window 211 of the wind shielding screen 210 to allow the airflow to pass through the cutout window 211 and thus to flow to the another portion of the radiator cooling package 110.

According to some embodiments of inventive concepts, the wind shielding method may further comprise: subsequently covering the another portion of the radiator cooling package 110 via the covering section 212 by shifting the cutout window 211 away from the another portion of the radiator cooling package 110 along with movement of the wind shielding screen 210.

FIG. 17 is a schematic diagram illustrating a computer program product 400 comprising a non-transitory computer readable medium 410 storing a program code 420 according to some embodiments of inventive concepts. The program code 420 is configured to be executed by the above recited wind shielding system 200 to perform the above recited wind shielding method for regulating an amount of airflow to a radiator cooling package 110 of a vehicle 100.

According to some embodiments of inventive concepts, with further reference to FIGS. 1-16, the program code 420 when executed a wind shielding system 200 may cause the wind shielding system 200 to: locate a wind shielding screen 210 of the wind shielding system 200 to the radiator cooling package 110; electrically couple each of a temperature sensor 230, a barometric pressure sensor 260 and an actuator 240 of the wind shielding system 200 with an electronic control unit (ECU) 220 of the wind shielding system 200; detect an air temperature of an ambient air surrounding the radiator cooling package 110 and a component temperature of a component associated with the radiator cooling package 110 by the temperature sensor 230; detect a barometric pressure of the ambient air by the barometric pressure sensor 260; perform calibration of the detected air temperature, the barometric pressure and/or the detected component temperature by the ECU 220; operatively couple the actuator 240 with the wind shielding screen 210; control the actuator 240 by the ECU 220 to move the wind shielding screen 210 between a closed configuration and an open configuration with respect to the radiator cooling package 110 based on the calibration; at least partially cover the radiator cooling package 110 and thus at least partially impede an airflow from flowing to the radiator cooling package 110 via the wind shielding screen 210 by moving the wind shielding screen 210 to the closed configuration; and expose the radiator cooling package 110 and thus allow the airflow to flow to the radiator cooling package 110 via the wind shielding screen 210 by moving the wind shielding screen 210 to the open configuration.

According to some embodiments of inventive concepts, the program code 420 may further cause the wind shielding system 200 to control the actuator 240 by the ECU 220 to move the wind shielding screen 210 to the closed configuration in response to subsequent to the calibration the ECU 220 determining that the detected air temperature of the ambient air surrounding the radiator cooling package 110 at the detected barometric pressure is less than a predetermined threshold based on the calibration.

According to some embodiments of inventive concepts, the program code 420 may further cause the wind shielding system 200 to control the actuator 240 by the ECU 220 to move the wind shielding screen 210 to the open configuration in response to subsequent to the calibration the ECU 220 determining that the detected component temperature of the component associated with the radiator cooling package 110 is larger than a predetermined threshold based on the calibration.

According to some embodiments of inventive concepts, the program code 420 may further cause the wind shielding system 200 to: electrically couple a driving unit 242 of the actuator 240 with the ECU 220; engage a rolling unit 244 of the actuator 240 with the driving unit 242; windably attach the wind shielding screen 210 to the rolling unit 244; and control the driving unit 242 by the ECU 220 to rotate the rolling unit 244 around a winding axis 246 of the rolling unit 244 so as to wind or unwind the wind shielding screen 210.

According to some embodiments of inventive concepts, the program code 420 may further cause the wind shielding system 200 to: move the wind shielding screen 210 towards the closed configuration by unwinding the wind shielding screen 210 from the rolling unit 244; and move the wind shielding screen 210 towards the open configuration by winding the wind shielding screen 210 onto the rolling unit 244.

According to some embodiments of inventive concepts, the program code 420 may further cause the wind shielding system 200 to control the driving unit 242 by the ECU 220 to move the rolling unit 244 along a trajectory 248 substantially perpendicular to the winding axis 246.

According to some embodiments of inventive concepts, the program code 420 may further cause the wind shielding system 200 to: locate the wind shielding screen 210 to a radiator 112 of the radiator cooling package 110; control the actuator 240 by the ECU 220 to move the wind shielding screen 210 between the closed configuration and the open configuration with respect to the radiator 112; at least partially cover the radiator 112 and thus at least partially impede the airflow from flowing to the radiator 112 via the wind shielding screen 210 by moving the wind shielding screen 210 to the closed configuration; and expose the radiator 112 via the wind shielding screen 210 and thus allow the airflow to flow to the radiator 112 by moving the wind shielding screen 210 to the open configuration.

According to some embodiments of inventive concepts, the program code 420 may further cause the wind shielding system 200 to: locate the wind shielding screen 210 to a condenser 114 of the radiator cooling package 110; control the actuator 240 by the ECU 220 to move the wind shielding screen 210 between the closed configuration and the open configuration with respect to the condenser 114; at least partially cover the condenser 114 and thus at least partially impede the airflow from flowing to the condenser 114 via the wind shielding screen 210 by moving the wind shielding screen 210 to the closed configuration; and expose the condenser 114 and thus allow the airflow to flow to the condenser 114 via the wind shielding screen 210 by moving the wind shielding screen 210 to the open configuration.

According to some embodiments of inventive concepts, the program code 420 may further cause the wind shielding system 200 to: locate the wind shielding screen 210 to an insect screen 116 of the radiator cooling package 110; control the actuator 240 by the ECU 220 to move the wind shielding screen 210 between the closed configuration and the open configuration with respect to the insect screen 116; at least partially cover the insect screen 116 and thus at least partially impede the airflow from flowing to the insect screen 116 via the wind shielding screen 210 by moving the wind shielding screen 210 to the closed configuration; and expose the insect screen 116 and thus allow the airflow to flow to the insect screen 116 via the wind shielding screen 210 by moving the wind shielding screen 210 to the open configuration.

According to some embodiments of inventive concepts, the program code 420 may further cause the wind shielding system 200 to: locate the wind shielding screen 210 to a grill 118 of the radiator cooling package 110; control the actuator 240 by the ECU 220 to move the wind shielding screen 210 between the closed configuration and the open configuration with respect to the grill 118; at least partially cover the grill 118 and thus at least partially impede the airflow from flowing to the grill 118 via the wind shielding screen 210 by moving the wind shielding screen 210 to the closed configuration; and expose the grill 118 and thus allow the airflow to flow to the grill 118 via the wind shielding screen 210 by moving the wind shielding screen 210 to the open configuration.

According to some embodiments of inventive concepts, the program code 420 may further cause the wind shielding system 200 to: control the actuator 240 by the ECU 220 to move the wind shielding screen 210 between the closed configuration, a partially closed/open configuration and the open configuration with respect to the radiator cooling package 110 based on the calibration; and partially cover or partially expose the radiator cooling package 110 and thus partially impede the airflow from flowing to while partially allow the airflow to flow to the radiator cooling package 110 via the wind shielding screen 210 by moving the wind shielding screen 210 to the partially closed/open configuration.

According to some embodiments of inventive concepts, the program code 420 may further cause the wind shielding system 200 to control the actuator 240 by the ECU 220 to move the wind shielding screen 210 to the partially closed/open configuration in response to subsequent to the calibration the ECU 220 determining that the detected air temperature of the ambient air surrounding the radiator cooling package 110 at the detected barometric pressure is less than a predetermined threshold and that the detected component temperature of the component associated with the radiator cooling package 110 is larger than another predetermined threshold.

According to some embodiments of inventive concepts, the program code 420 may further cause the wind shielding system 200 to electrically couple a power supply 250 of the wind shielding system 200 with the ECU 220, the temperature sensor 230, the barometric pressure sensor 260 and the actuator 240.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

1. A wind shielding system for a radiator cooling package of a vehicle, the wind shielding system comprising:
a wind shielding screen;
an electronic control unit (ECU);
a temperature sensor; and
an actuator,
wherein the wind shielding screen is configured to be located adjacent to the radiator cooling package,
wherein the temperature sensor and the actuator are each electrically coupled with the ECU,
wherein the temperature sensor is configured to detect an air temperature of an ambient air surrounding the radiator cooling package,
wherein the actuator is operatively coupled with the wind shielding screen and is controllable by the ECU to move the wind shielding screen between a closed configuration and an open configuration with respect to the radiator cooling package based on a determination whether ice may or may not become formed on the radiator cooling package from an airflow at the detected air temperature, and
wherein the wind shielding screen in the closed configuration is configured to at least partially impede the airflow from flowing to the radiator cooling package by at least covering the radiator cooling package and thus to at least partially impede formation of ice on the radiator cooling package from the airflow.

2. The wind shielding system of claim 1,
wherein the actuator is controllable by the ECU to move the wind shielding screen to the closed configuration in response to the ECU determining that the detected air temperature is less than a predetermined threshold at which ice may become formed on the radiator cooling package from the airflow.

3. The wind shielding system of claim 1,
wherein the actuator is controllable by the ECU to move the wind shielding screen to the open configuration in response to the ECU determining that the detected air temperature is larger than a predetermined threshold at which ice may not become formed on the radiator cooling package from the airflow.

4. The wind shielding system of claim 1, further comprising:
a barometric pressure sensor,
wherein the barometric pressure sensor is electrically coupled to the ECU,
wherein the barometric pressure sensor is configured to detect a barometric pressure of the ambient air, and
wherein the actuator is controllable by the ECU to move the wind shielding screen between the closed configuration and the open configuration with respect to the radiator cooling package further based on a determination whether ice may or may not become formed on the radiator cooling package from the airflow at the detected air temperature under the detected barometric pressure.

5. The wind shielding system of claim 1,
wherein the temperature sensor is configured to further detect a component temperature of a component associated with the radiator cooling package,
wherein the actuator is controllable by the ECU to move the wind shielding screen between the closed configuration and the open configuration with respect to the radiator cooling package further based on a determination whether the component associated with the radiator cooling package may become frozen or may become burned at the detected component temperature,
wherein the wind shielding screen in the closed configuration is configured to further at least partially impede the component associated with the radiator cooling package from becoming frozen due to the airflow decreasing the component temperature, and
wherein the wind shielding screen in the open configuration is configured to allow the airflow to flow to the radiator cooling package by exposing the radiator cooling package and thus to impede the component associated with the radiator cooling package from becoming burned due to lacking the airflow decreasing the component temperature.

6. The wind shielding system of claim 5,
wherein the actuator is controllable by the ECU to move the wind shielding screen to the closed configuration in response to the ECU determining that the detected component temperature is less than a predetermined threshold at which the component associated with the radiator cooling package may become frozen.

7. The wind shielding system of claim 5,
wherein the actuator is controllable by the ECU to move the wind shielding screen to the open configuration in response to the ECU determining that the detected component temperature is larger than a predetermined threshold at which the component associated with the radiator cooling package may become burned.

8. The wind shielding system of claim 5,
wherein the actuator is controllable by the ECU to move the wind shielding screen further between the closed configuration, a partially closed/open configuration and the open configuration with respect to the radiator cooling package, and
wherein the wind shielding screen in the partially closed/open configuration is configured to partially impede the airflow from flowing to while to partially allow the airflow to flow to the radiator cooling package by partially covering or partially exposing the radiator cooling package.

9. The wind shielding system of claim 8,
wherein the actuator is controllable by the ECU to move the wind shielding screen to the partially closed/open configuration in response to the ECU determining that the detected air temperature is less than a predetermined threshold at which ice may become formed on the radiator cooling package from the airflow and that the detected component temperature is larger than another predetermined threshold at which the component associated with the radiator cooling package may become burned.

10. The wind shielding system of claim 1,
wherein the actuator comprises a driving unit and a rolling unit,
wherein the driving unit is electrically coupled with the ECU,
wherein the rolling unit is engaged with the driving unit,
wherein the wind shielding screen is windably attached to the rolling unit, and
wherein the driving unit is controllable by the ECU to rotate the rolling unit around a winding axis of the rolling unit so as to wind or unwind the wind shielding screen.

11. The wind shielding system of claim 10,
wherein the wind shielding screen is moved towards the closed configuration in response to the wind shielding screen being unwound from the rolling unit, and
wherein the wind shielding screen is moved towards the open configuration in response to the wind shielding screen being wound onto the rolling unit.

12. (canceled)

13. The wind shielding system of claim 1,
wherein the wind shielding screen is configured to be located adjacent to a radiator of the radiator cooling package.

14. The wind shielding system of claim 1,
wherein the wind shielding screen is configured to be located adjacent to a condenser of the radiator cooling package.

15. The wind shielding system of claim 1,
wherein the wind shielding screen is configured to be located adjacent to an insect screen of the radiator cooling package.

16. The wind shielding system of claim 1,
wherein the wind shielding screen is configured to be located adjacent to a grill of the radiator cooling package.

17. The wind shielding system of claim 1,
wherein the wind shielding screen comprises a water-resistant or water-proof material.

18. The wind shielding system of claim 1,
wherein the temperature sensor comprises at least one of an A/C fallback mode temperature sensor, a coolant temperature sensor, an ambient air temperature sensor, a boost temperature sensor, and a retarder temperature sensor.

19. The wind shielding system of claim 1,
wherein the wind shielding screen comprises a covering section and a cutout window formed thereon,
wherein the covering section is configured to impede the airflow to pass therethrough, and
wherein the cutout window is configured to allow the airflow to pass therethrough.

20. A vehicle, comprising:
a radiator cooling package; and
a wind shielding system,
wherein the wind shielding system comprises a wind shielding screen, an electronic control unit (ECU), a temperature sensor and an actuator,
wherein the wind shielding screen is located adjacent to the radiator cooling package,
wherein the temperature sensor and the actuator are each electrically coupled with the ECU,
wherein the temperature sensor is configured to detect an air temperature of an ambient air surrounding the radiator cooling package,
wherein the actuator is operatively coupled with the wind shielding screen and is controllable by the ECU to move the wind shielding screen between a closed configuration and an open configuration with respect to the radiator cooling package based on a determination whether ice may or may not become formed on the radiator cooling package from an airflow at the detected air temperature, and
wherein the wind shielding screen in the closed configuration is configured to at least partially impede the airflow from flowing to the radiator cooling package by at least covering the radiator cooling package and thus to at least partially impede formation of ice on the radiator cooling package from the airflow.

21. A wind shielding method comprising:
locating a wind shielding screen of a wind shielding system of a vehicle adjacent to a radiator cooling package of the vehicle;
electrically coupled each of a temperature sensor and an actuator of the wind shielding system with an electronic control unit (ECU) of the wind shielding system;
detecting an air temperature of an ambient air surrounding the radiator cooling package by the temperature sensor;
operatively coupling the actuator with the wind shielding screen;
controlling the actuator by the ECU to move the wind shielding screen between a closed configuration and an open configuration with respect to the radiator cooling package based on a determination whether ice may or may not become formed on the radiator cooling package from an airflow at the detected air temperature; and
at least partially impeding the airflow from flowing to the radiator cooling package by at least covering the radiator cooling package via moving the wind shielding screen to the closed configuration, thereby at least partially impeding formation of ice on the radiator cooling package from the airflow.

22-25. (canceled)
